(19) United States
(12) Patent Application Publication
(10) Pub. No.: US 2025/0284122 A1
(43) Pub. Date: Sep. 11, 2025

(54) LAMINATED GLAZING FOR HEAD-UP DISPLAY

(71) Applicant: SAINT-GOBAIN GLASS FRANCE, COURBEVOIE (FR)

(72) Inventors: Denis GUIMARD, AUBERVILLIERS (FR); Romain HIVET, AUBERVILLIERS (FR)

(21) Appl. No.: 18/860,342

(22) PCT Filed: Apr. 26, 2023
(86) PCT No.: PCT/EP2023/061037

§ 371 Date: Oct. 25, 2024

(30) Foreign Application Priority Data
Apr. 28, 2022 (FR) 2203982

(51) Int. Cl. G02B 27/01; B32B 17/10; B60J 1/00; B60J 1/02; C03C 17/36

(52) U.S. Cl. CPC G02B 27/0101; B32B 17/10036; B32B 17/10211; C03C 17/3644; C03C 17/366; C03C 17/3681; B60J 1/001; B60J 1/02; C03C 2217/24; C03C 2217/256; C03C 2217/948; C03C 2218/156; G02B 2027/012

(57) ABSTRACT

A laminated glazing includes a first glass sheet, a second glass sheet, a lamination interlayer in adhesive contact with the outer first glass sheet and the inner second glass sheet; a functional coating of thin layers arranged on the second glass sheet and including, starting from the second glass sheet, a first dielectric module, a metallic functional layer and a second dielectric module, the metallic functional layer being located between the first dielectric module and the second dielectric module. The first dielectric module and/or the second dielectric module include a tungsten oxide layer which is made of pure sub-stoichiometric tungsten oxide, WOₓ, with x between 2.55 and 2.98, or which is made of doped tungsten oxide including at least one doping element selected from the chemical elements of group 1 according to the IUPAC nomenclature.

### TECHNICAL FIELD

The invention relates to laminated glazing for head-up displays.

### TECHNICAL BACKGROUND

Modern vehicles today are equipped with head-up displays (HUDs).

These systems or devices include a projector, usually located close to the vehicle dashboard, configured to project an image onto an area of the vehicle windshield. The projected image appears to the vehicle driver as a virtual image behind the windshield, displaying information such as vehicle speed, navigation and warnings directly in the driver's field of vision. The driver no longer looks away from the road to consult this information and remains alert to events taking place outside the vehicle. HUD systems or devices thus contribute to improving road safety.

Most HUD devices are based on the emission of polarized electromagnetic radiation with s-type polarization and an angle of incidence of around 65° to the normal to the windshield. This angle is close to the Brewster angle for a glass-air interface, which is around 56.5° for soda-lime glass. The projected image is then reflected by the two main external surfaces of the windshield. In addition to the main image, a more or less offset secondary image also appears, more or less partially covering the main image. This secondary image is known as a “ghost image” or “double image”.

To reduce the ghosting effect, the main surfaces of the windshield are usually arranged at different angles by inserting a lamination interlayer of varying thickness, so that the ghost image and the main image are superimposed. This type of glazing is generally known as wedge glazing or wedge windshield.

By way of example, EP0420228 A2 [HUGHES AIRCRAFT CO [US]] Apr. 3, 1991 describes a windshield comprising a lamination interlayer whose thickness progressively decreases between a first and a second windshield side so that the two sheets of glass in adhesive contact with said interlayer have two different angles of inclination with respect to the projector.

However, this type of glazing is expensive to manufacture, limited to certain viewing angles of the projected image, and does not prevent the formation of a ghost image when the glazing includes a functional coating.

Alternatively, it is common practice to use HUD devices whose implementation is based on the emission of electromagnetic radiation polarized according to a p-type polarization and onto a windshield comprising a functional coating adapted to the formation of a new reflective interface within said windshield for this type of radiation.

Since p-polarized electromagnetic radiation is emitted towards the windshield at an angle of incidence close to the Brewster angle, it is not reflected by the glass-air interfaces. Reflection occurs only at the reflective interface formed by the functional coating. Various types of functional coating can be used.

WO 2005/017600 A1 [3M INNOVATIVE PROPERTIES CO [US]] Feb. 24, 2005 describes a polarizing optical film comprising a plurality of individual layers with different optical refractive indices. The film is intended to be laminated into a laminated glazing to form a head-up display windshield comprising a zone that reflects predominantly visible light polarized according to p-polarization. The film can also reflect infrared radiation to reduce greenhouse effect phenomena in a vehicle.

DE 102014220189 A1 [CONTINENTAL AUTOMOTIVE GMBH [DE]] Apr. 7, 2016 describes a laminated glazing unit comprising a metallic layer based on silver or aluminum and having a thickness of between 5 nm and 9 nm. The metal layer enables p-polarized visible light to be reflected.

WO 2016/058474 A2 [FUYAO GLASS IND GROUP CO LTD [CN]] Apr. 21, 2016, WO 2021/104800 A1 [SAINT GOBAIN [FR]] Jun. 3, 2021, WO 2019/046157 A1 [VITRO FLAT GLASS LLC [US]] Mar. 7, 2019, WO 2020/094422 A1 [SAINT GOBAIN [FR]] May 14, 2020 describe laminated glazings for head-up displays provided with a functional coating comprising one or more metallic functional layers, in particular silver-based, allowing the reflection of visible light polarized according to a p-polarization. The functional coating can also include dielectric layers which, possibly combined with the metallic functional layers, confer other properties such as solar control and/or neutralization of the coating's colors in transmission and/or reflection.

Laminated and non-laminated “solar control” glazings also includes glazings with thin-film stacks and no functional metal layers to guarantee a certain transparency to radio frequencies for on-board telecoms systems. Instead of functional metal layers, functional layers that absorb infrared radiation are generally used. They may be based on oxides and/or nitrides.

JP H0812378 A [NISSAN MOTOR] Jan. 16, 1996 describes a functional “solar control” stack comprising a tungsten oxide layer arranged between two dielectric layers. The stack makes it possible to reduce the surface electrical resistance and to increase the transparency to radio waves relative to the stacks comprising a metallic functional layer, in particular based on silver.

JP 2010180449 A [SUMITOMO METAL MINING CO [JP]] Aug. 19, 2010 describes a layer based on tungsten oxide deposited by sputtering using a tungsten oxide target comprising chemical elements selected from hydrogen, alkali metals, alkaline earth metals and rare earth metals. The layer has a “solar control” function by virtue of its high absorption of near-infrared radiation.

EP 3686312 A1 [SUMITOMO METAL MINING CO [JP]] Jul. 29, 2020 describes a layer based on tungsten oxide doped with cesium, and a method for depositing such a layer by sputtering. The layer has a transparency to radio waves and a “solar control” function by virtue, in particular, of its high absorption of infrared radiation.

For some applications in the automotive industry, in addition to solar control functions, the glazings must comprise a heating function in order to allow, for example, its defrosting and/or its defogging.

Whether these glazings are in the form of windshields, quarter windows, small windows, larger windows and/or glazed roofs, the heating function is generally provided by the solar control stack itself. Thanks to the metal layers it contains, the stack is an electrical conductor. When supplied with electricity by the alternator and/or the vehicle battery, it can release heat through the Joule effect.

For obvious safety reasons, alternators and/or vehicle batteries generally deliver a low electrical voltage at their terminals, typically between 12 V and 48 V, often around 14 V. Also, in order to release enough heat for effective demisting and/or defrosting, the surface resistivity of the stack must be low enough to accentuate the Joule effect at low voltage.

EP0726232 A2, EP1614325 A1 and US2015229030A1 describe examples of solar control heatable windshields wherein an electrically conductive stack provides simultaneous solar control and heating functions.

### SUMMARY OF THE INVENTION

### Technical Problem

There is a need for laminated glazings that combine “solar control” properties with head-up display applications and a heating function. Such glazing must satisfy a fivefold requirement: low solar factor, high light transmission, color neutrality in reflection and/or transmission, high reflection of p-polarized electromagnetic radiation in the visible spectrum, and low surface electrical resistance.

### Solution to the Technical Problem

A first aspect of the invention relates to a laminated glazing as disclosed in claim 1, the dependent claims being advantageous embodiments. The laminated glazing comprises:
a first glass sheet;
a second glass sheet;
a lamination interlayer in adhesive contact with the first glass sheet and the second glass sheet;
a functional coating of thin layers arranged on the second glass sheet and comprising, starting from the second glass sheet, a first dielectric module, a metallic functional layer and a second dielectric module, said metallic functional layer being located between the first dielectric module and the second dielectric module;
said glazing being characterized in that:
the first dielectric module and/or the second dielectric module comprises (or comprise) a tungsten oxide layer, and in that:
said tungsten oxide layer is made of pure sub-stoichiometric tungsten oxide, WOx, with x preferably between 2.55 and 2.98, or
said tungsten oxide layer is a doped tungsten oxide and comprises at least one doping element selected from the chemical elements of group 1 according to the IUPAC nomenclature.

Other advantageous embodiments are described in the detailed disclosure.

Preferably, said first glass sheet is an outer glass sheet and said second glass sheet is an inner glass sheet.

Said functional metal layer may be the sole functional metal layer of said functional coating.

According to a second aspect of the invention, a head-up display projection device is provided comprising a laminated glazing according to the first aspect of the invention.

According to a third aspect of the invention, a method is provided for manufacturing a laminated glazing according to the first aspect of the invention.

### Advantages of the Invention

The remarkable advantage of the glazing according to the invention is that it has a low solar factor, high light transmission, color neutrality in reflection and/or transmission, high reflection of electromagnetic radiation polarized according to a p polarization in the visible spectrum, and low surface electrical resistance.

More specifically, the glazing according to the invention has a selectivity of over 1.3, or even 1.35 for a light transmission of over 70%. It is also color neutral in transmission and reflection.

In head-up application, the glazing according to the invention has a reflection level of electromagnetic radiation in p-type polarization at 65° greater than 16%, or even 18%, or even 19% in some embodiments.

The glazing according to the invention also has an electrical surface resistance of less than 3.5Ω/□, in particular less than 2.5 or even 2.4 for certain embodiments. These electrical resistance values are ideal for electric heating applications.

### BRIEF DESCRIPTION OF THE DRAWINGS

FIG. 1 is a schematic depiction of a laminated glazing according to the invention.

FIG. 2 a detailed schematic depiction of the functional coating shown in FIG. 1.

FIG. 3 is a schematic depiction of a projection device for a head-up display.

FIG. 4 is a graphic depiction of the light transmission and of the direct solar transmittance for the examples according to the invention and two counterexamples.

FIG. 5 is a graphic depiction of the light transmission and of the total solar factor for the examples according to the invention and two counterexamples.

### DETAILED DESCRIPTION OF EMBODIMENTS

The following definitions and conventions are used.

The term “above”, respectively “below”, describing the position of a layer or of an assembly of layers and defined in relation to the position of another layer or another assembly, means that said layer or said assembly of layers is closer to, respectively further from, the substrate.

These two terms, “above” and “below”, do not at all mean that the layer or the assembly of layers which they describe and the other layer or the other assembly with respect to which they are defined are in contact. They do not exclude the presence of other intermediate layers between these two layers. The expression “in contact” is explicitly used to indicate that no other layer is positioned between them.

Without any fuller information or qualifier, the term “thickness” used for a layer corresponds to the physical, real or geometric thickness of said layer. It is expressed in nanometers.

By the expressions “layers” or “thin layers” is meant a layer of material as commonly defined in the technical field. Typically, this is a thin layer with a thickness of less than 1 μm, or even less than 500 nm, typically less than 100 nm.

The expression “dielectric module” denotes one or more layers in contact with one another forming an assembly of layers which is dielectric overall, that is to say that it does not have the functions of a functional metal layer. If the dielectric module comprises several layers, they may themselves be dielectric. The physical, real or geometric thickness, of a dielectric module of layers, corresponds to the sum of the physical, real or geometric thicknesses, of each of the layers which constitute it.

In the present description, the expressions “a layer of” or “a layer based on”, used to describe a material or a layer as to what it contains, are used equivalently. They mean that the mass fraction of the constituent that it comprises is at least 50%, in particular at least 70%, preferably at least 90%. In particular, the presence of minority or doping elements is not excluded.

The term “transparent” used to describe a substrate means that the substrate is preferably colorless, non-opaque and non-translucent in order to minimize the absorption of the light and thus retain a maximum light transmission in the visible electromagnetic spectrum.

“Light transmittance,” TL, is understood to mean the light transmittance, denoted TL, as defined and measured and/or calculated in the standard ISO 13837:2021.

“Direct solar transmittance”, TE, is understood to mean the direct solar transmittance as defined and calculated according to the standard ISO 13837:2021.

“Solar factor”, TTS (or T_{TS}), is understood to mean the solar factor as defined according to the standard ISO 13837:2021.—convention A. It is equal to the sum of the direct solar transmittance, TE, and of the secondary heat flux, qi.

“Selectivity”, s, is understood to mean the ratio of the light transmission, LT, to the solar factor TTS.

In accordance with the nomenclature of IUPAC, group 1 of the chemical elements comprises hydrogen and alkaline elements, that is, lithium, sodium, potassium, rubidium, cesium and francium.

The expression “optical refraction index” is understood as the optical refraction index, n, as defined in the technical field, in particular according to the Forouhi & Bloomer model described in the Forouhi & Bloomer, Handbook of Optical Constants of Solids II, Palik, E. D. (ed.), Academic Press, 1991, Chapter 7.

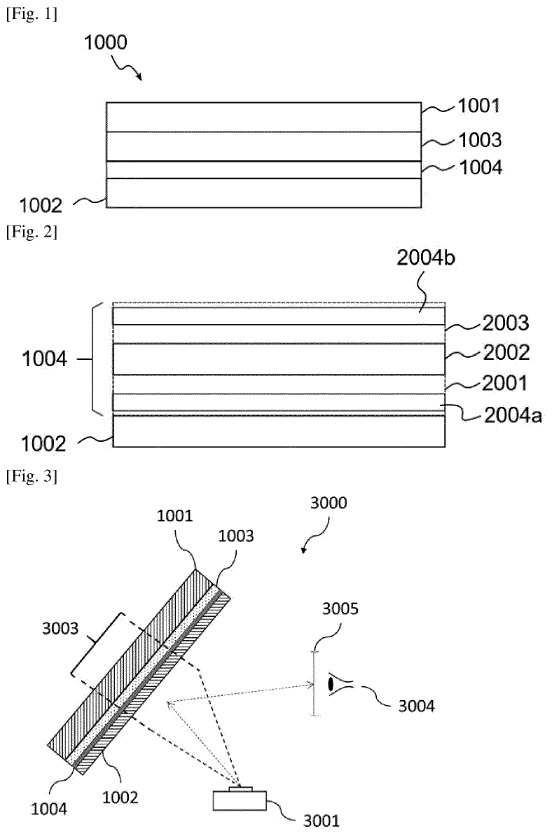

According to a first aspect of the invention, with reference to FIGS. 1 and 2, a laminated glazing 1000 is provided, comprising
a first glass sheet 1001;
a second glass sheet 1002;
a lamination interlayer 1003 in adhesive contact with the first glass sheet 1001, here an outer glass sheet, and the second glass sheet 1002, here an inner glass sheet;
a functional coating 1004 of thin layers arranged on the second glass sheet 1002 and comprising, starting from the second glass sheet 1002, a first dielectric module 2001, a metallic functional layer 2002 and a second dielectric module 2003, said metallic functional layer 2002 being located between the first dielectric module 2001 and the second dielectric module 2003.

The said glazing is characterized in that
the first dielectric module 2001 and/or the second dielectric module 2003 comprise a tungsten oxide layer 2004a, 2004b and in that:
the tungsten oxide is made of pure sub-stoichiometric tungsten oxide, WOₓ, with x preferably between 2.55 and 2.98, or
the tungsten oxide comprises at least one doping element selected from the chemical elements of group 1 according to the IUPAC nomenclature.

Glass sheets 1001, 1002 can be mineral or glass-ceramic. The glass may preferably be a glass of soda-lime-silica, borosilicate, aluminosilicate or else alumino-borosilicate type. According to a preferred embodiment of the invention, the glass sheets 1001, 1002 are sheets of soda-lime-silica mineral glass.

According to some embodiments, the first glass sheet 1001 and/or the second glass sheet 1002 can be a thin glass sheet, in particular with a thickness of between 0.4 and 1.1 mm, especially between 0.4 and 0.7 mm.

In preferred embodiments, glass sheets 1001, 1002 are transparent glass sheets.

According to certain embodiments, one of the two glass sheets 1001, 1002 may be a mineral glass tinted in the mass. The tinting or coloring in the mass of a mineral glass is known and abundantly described in the technical literature. The coloring may generally be obtained by adding coloring oxide in the glass chemical composition. Examples of coloring oxides may be iron II oxide, copper oxide, chromium oxide, nickel oxide, gold oxide, manganese oxide, cobalt oxide, uranium oxide, neodymium oxide and erbium oxide.

Mixtures of oxides such as copper and tin oxide, or ionic complexes, such as iron-sulfur or cadmium-sulfur complex, can also be used.

The lamination interlayer 1003 may consist of one or more layers of thermoplastic material. Examples of thermoplastic material are polyurethane, polycarbonate, polyvinyl butyral (PVB), polymethyl methacrylate (PMMA), ethylene vinyl acetate (EA) or an ionomer resin.

The lamination interlayer 1003 may be in the form of a multilayer film. It may also have particular functionalities such as, for example, acoustic or anti-UV properties.

Typically, the lamination interlayer 1003 comprises at least one PVB layer. Its thickness ranges from 50 μm to 4 mm. In general, it is less than 1 mm.

The function of the functional metal layer 2002 is to reflect infrared radiation and/or part of the solar radiation. It may be any suitable metal, for example based on gold or based on silver. The thickness of the functional metal layer 1003 may typically be between 2 nm and 25 nm, preferably between 10 nm and 20 nm.

According to preferred embodiments, the functional metal layer 2002 is silver-based or made of silver.

According to certain preferred embodiments, the laminated glazing 1000, when used as a glazing of a motor vehicle, for example as windshield, is such that the second glass sheet 1002 is located inside the vehicle. In other words, the functional coating 1004 is placed on face 3 of the glazing starting from the second glass sheet 1002 in the interior of the vehicle, the face 4 being the face oriented towards the interior; or on face 2 of the glazing starting from the first glass sheet 1001 oriented on the exterior of the vehicle, the face 1 being the face oriented toward the exterior.

In accordance with the first aspect of the invention, the first dielectric module 2001 and/or the second dielectric module 2003 comprise a tungsten oxide layer 2004a, 2004b. Thus, in a first embodiment, only the first dielectric module 2001 comprises a tungsten oxide layer 2004a. In a second embodiment, only the second dielectric module 2002 comprises a tungsten oxide layer 2004b. In a third embodiment, each of the dielectric modules 2001, 2002 comprises a tungsten oxide layer 2004a, 2004b.

When the first dielectric module and the second dielectric module each comprise a tungsten oxide layer, the tungsten oxide of the two tungsten oxide layers can be of different composition.

According to other preferred embodiments, the optical refractive index of the tungsten oxide layer 2004a, 2004b is decreasing monotonically with the wavelength from a maximum value greater than 2.4 at 350 nm up to a minimum value between 600 nm and 1400 nm so that the difference between the maximum value and the minimum value is greater than 0.8, preferably greater than 1.0, or even greater than 1.4.

In other words, the value of the optical refractive index decreases monotonically by at least 0.8, preferably at least 1.0, or even at least 1.4 between a maximum value greater than 2.4 at 350 nm and a minimum value between 600 nm and 1400 nm. As an example, the optical refractive index value can decrease monotonically by at least 0.8, preferably at least 1.0, or even at least 1.4 between a maximum value greater than 2.4 at 350 nm and a minimum value less than 2.3 between 600 nm and 1400 nm, especially between 800 nm and 1100 nm.

While not particularly required to achieve the effects of the present invention, these optical refractive index values can nevertheless be advantageous for improving color neutrality in transmission and reflection.

According to certain preferred complementary embodiments, the optical extinction coefficient of the tungsten oxide layer 2004a, 2004b may be less than 0.2, or even 0.1 at 500 nm and less than 2.0, or even 1.5 at 1200 nm. The selectivity can thus be advantageously further increased.

The tungsten oxide in the tungsten oxide layer(s) 2004a, 2004b can be pure sub-stoichiometric tungsten oxide, WOₓ, with x preferably between 2.55 and 2.98, or even between 2.6 and 2.95. A value of x between 2.98 and 3.02 is considered to produce a pure stoichiometric tungsten oxide, WO₃. These characteristics combined with the presence of a metal functional layer have a synergistic effect on the increase in selectivity.

Surprisingly, a layer of tungsten oxide made of pure sub-stoichiometric tungsten oxide, WOₓ, has unexpected optical characteristics, in particular in terms of the evolution of the optical extinction coefficient and of the refractive index as a function of the wavelength of the electromagnetic radiation. These characteristics combined with the presence of a metal functional layer have a synergistic effect on the increase in selectivity.

Surprisingly, a layer of tungsten oxide 2004a, 2004b, comprising a doping element chosen by the elements of group 1 according to the nomenclature of the IUPAC has unexpected optical characteristics, in particular in terms of the evolution of the optical extinction coefficient and of the refractive index as a function of the wavelength of the electromagnetic radiation.

The optical extinction coefficient and the optical diffraction index can vary according to:
sub-stoichiometry or
the nature and quantity of the doping element(s) selected from Group 1 elements according to IUPAC nomenclature.

However, it is currently difficult to establish a law of general behavior of the optical extinction coefficient and of the refractive index according to a sub-stoichiometric part or other part the nature and/or the quantity of the doping element(s).

According to certain particular embodiments, the tungsten oxide layer 2004a, 2004b, made of doped tungsten oxide, comprises the doping element X or the doping elements X1, X2, . . . in a proportion such that the molar ratio, X/W of said element on tungsten, W, or the sum of the molar ratios of each element on tungsten (X1+X2+ . . . )/W is between 0.01 and 0.4, preferably between 0.01 and 0.2, or even between 0.01 and 0.1.

It was observed that these molar ratio values can advantageously make it possible to obtain the values of optical extinction coefficient and of refractive index described in the preceding embodiments while limiting the quantity of doping elements. Furthermore, a saving on the exploitation of the mineral resources for the doping elements may possibly result, as well as a reduction in costs.

According to certain embodiments, the tungsten oxide layer 2004a, 2004b made of doped tungsten oxide comprises at least one doping element selected from hydrogen, lithium, sodium, potassium and cesium. Among the elements of group 1, these particular elements can make it possible to obtain the most optimal values of optical extinction coefficient and refractive index for the desired technical effects.

According to particularly preferred embodiments, the tungsten oxide layer 2004a, 2004b made of doped tungsten oxide comprises cesium as a doping element, and the molar ratio of cesium to tungsten is between 0.01 and 0.4, preferably between 0.01 and 0.2. These embodiments make it possible to obtain the best performance as to the increase in selectivity, the preservation of neutral colors, and the cost savings.

According to certain advantageous embodiments, the physical thickness of the tungsten oxide layer(s) 2004a, 2004b can be between 2 nm and 50 nm, in particular between 5 nm and 30 nm, preferably between 5 nm and 20 nm. These intervals of thicknesses are sufficient to obtain the remarkable advantages of the first aspect of the invention.

According to embodiments, the first dielectric module 2001 and/or the second dielectric module 2002 may comprise one or more layers with a refractive index of less than 2.45 at 550 nm.

The layer or layers with a refractive index less than 2.45 at 550 nm are preferably based on oxide or nitride of silicon, zirconium, titanium, or tin and zinc. As examples, they may be based on silicon nitride, silicon oxide, zirconium nitride or zinc and tin oxide.

According to embodiments, the functional coating 1004 of thin layers further comprises a blocking metal overlayer, preferably based on nickel and chromium alloy, located above and in contact with the functional metal layer and/or a blocking metal underlayer, preferably based on nickel and chromium alloy, located below and in contact with the functional metal layer.

The presence of a blocking metal overlayer and/or of a blocking metal underlayer makes it possible to advantageously increase the durability of the stack, for example in terms of mechanical resistance to brushing or scratching. It also makes it possible to avoid deterioration, for example oxidation, of the metal functional layer 2002 during the deposition of the subsequent layers and/or during heat treatments, in particular by limiting the diffusion of certain chemical elements from the adjacent layers and/or the diffusion of oxygen.

In advantageous embodiments, the first dielectric module 2001 and/or the second dielectric module 2002 may comprise a layer based on indium tin mixed oxide, indium zinc mixed oxide, fluorine-doped tin oxide, aluminum-doped zinc oxide, gallium-doped zinc oxide, antimony-doped tin oxide and/or niobium-doped titanium oxide.

Surprisingly, it was found that combining one of these layers with a doped tungsten oxide layer as described in the present invention advantageously reduced the solar factor, TTS, thanks to a higher absorption of infrared radiation without detriment to color neutrality and transmission.

Preferably, the thickness of the layer based on indium-tin mixed oxide, indium-zinc mixed oxide, fluorine-doped tin oxide, aluminum-doped zinc oxide, gallium-doped zinc oxide, antimony-doped tin oxide and/or niobium-doped titanium oxide is between 50 and 100 nm.

This layer is to be distinguished from any wetting layers, also known as crystallization layers, located under and in contact with the metal functional layers, which are generally based on aluminum-doped zinc oxide and are generally less than 15 nm thick.

In preferred embodiments, the first dielectric module 2001 and/or the second dielectric module 2002 can comprise an indium tin mixed oxide layer with a thickness of between 50 nm and 100 nm.

According to a second aspect of the invention, with reference to FIG. 3, a projection device 3000 is provided for head-up display comprising:
a laminated glass 1000 according to the first aspect of the invention;
a head-up projector 3001 configured to emit electromagnetic radiation 3002 onto at least one zone 3003 of laminated glass 1000, the electromagnetic radiation being at least partially polarized according to a p polarization.

In operation, the head-up projector 3001 projects an image onto the zone 3003 of the laminated glass, which acts like a screen. The image is perceived by a user 3004, in this case a driver, as a virtual image when he looks into the solid observation angle 3005 adapted to the perception of said image in the zone 3003 of the laminated glazing 1000.

Laminated glazing manufacturing methods are well known in the glass industry. By way of examples, a method for manufacturing laminated glazing can be a method for laminating a lamination interlayer between two sheets of glass. The glass sheets can be preformed, for example in a curved shape using a bending process. They can also be coated with one or more thin-film coatings using any suitable thin-film deposition process.

The methods for depositing thin layers on substrates, in particular glass sheets, are methods well known in industry. By way of example, the deposition of a stack of thin layers on a glass substrate is carried out by successive depositions of each thin layer of said stack by passing the glass substrate through a succession of deposition cells suitable for depositing a given thin layer.

The deposition cells can use deposition methods such as magnetic field assisted sputtering, ion beam assisted deposition (IBAD), evaporation, chemical vapor deposition (CVD), plasma enhanced chemical vapor deposition (PECVD), low pressure chemical vapor deposition (LPCVD), etc.

The magnetic field enhanced sputtering deposition method is particularly used. The conditions for deposition of layers are widely documented in the literature, for example in patent applications WO2012/093238 A1 and WO2017/00602 A1.

When a pure tungsten metal target or a pure tungsten oxide target is used, it can be used to deposit a layer of pure sub-stoichiometric tungsten oxide, WOₓ, with x preferably between 2.55 and 2.98.

One advantage of using a ceramic target (that is, with oxygen) over a metal target, particularly for rotating targets, is that the ceramic target is lighter, making it easier to control the method using this ceramic target.

When a ceramic or metallic target is used, it may in particular contain one or more doping elements in the proportions as described for the doped tungsten oxide layer in some embodiments of the first aspect of the invention.

According to a third aspect of the invention, a method is provided for manufacturing a laminated glazing 1000 according to the first aspect of the invention, wherein the tungsten oxide layer 2004a, 2004b of doped tungsten oxide is deposited by a magnetron sputtering method using a tungsten oxide target doped using a chemical element chosen from the chemical elements of group 1 according to the IUPAC nomenclature.

The tungsten oxide target may in particular contain one or more doping elements in a proportion as described for the doped tungsten oxide layer in some embodiments of the first aspect of the invention.

According to particularly preferred embodiments, the tungsten oxide layer comprises cesium as a doping element, and the molar ratio of cesium to tungsten is between 0.01 and 0.2, preferably between 0.01 and 0.1. These embodiments make it possible to obtain the best performance as to the increase in selectivity, the preservation of neutral colors, and the cost savings.

What is most important in the context of the invention is that absorption in the visible range of the tungsten oxide layer(s) material is as low as possible in the visible range (wavelength 380 to 780 nm) to maximize the gain in selectivity.

The tungsten oxide layer can be deposited by sputtering using the aforementioned target under a deposition atmosphere composed of 60% to 100% argon and 0% to 40% dioxygen, preferably 70% to 85% argon and 15% to 30% dioxygen.

The tungsten oxide layer may be deposited under a pressure between 1 to 15 m Torr, preferably 3 to 10 m Torr.

Preferably, the deposition can be carried out cold, that is to say at a temperature of less than 100° C., in particular between 20° C. and 60° C., for the substrate.

The deposition can also be carried out hot, in particular at a temperature between 100° C. and 400° C.

According to particular embodiments, the glass sheet 1002, after deposition of the stack 1004, can undergo an annealing heat treatment. The annealing temperature may be between 450° C. and 800° C., in particular between 550° C. and 750° C., or even between 600° C. and 700° C. The annealing time may be between 5 min and 30 min, in particular between 5 min and 20 min, or even between 5 min and 10 min.

The laminated glazing 1000 according to the first aspect is particularly suitable for head-up display applications in a land, sea or air vehicle, preferably in a motor vehicle, rail vehicle, aircraft or boat, in particular a passenger car or truck.

All the embodiments described, whether they relate to the first aspect or the second aspect of the invention, can be combined with one another without modification or particular adaptation. In the event that technical incompatibilities appear during the implementation of one of these combinations, it is within the scope of the person skilled in the art to be able to solve them by means of their knowledge without this requiring undue effort, in particular by implementing a research program.

### EXAMPLES

The features and advantages of the invention are shown by the examples and counter-examples described hereinafter.

Three examples, E1-E3, in accordance with the invention, and two counterexamples, CE1 and CE2, not in accordance with the invention, are described in Table 1, which shows the composition and thickness of the glass sheets 1001, 1002, the lamination interlayer 1003 and the various thin layers of the functional coating 1004. The thicknesses of the thin layers of the 1004 functional coating are expressed in nanometers. The numbers in the first two columns correspond to the references of the figures.

In examples E1 to E3, the tungsten oxide layer 1005, denoted CWO, is a cesium-doped tungsten oxide layer. It has a refractive index of around 2.4 at 550 nm.

The molar ratio of cesium to tungsten in the layer is about 0.05-0.06.

TABLE 1

| | | | E1 | | E2 | | E3 | | CE1 | | CE2 | |
|---|---|---|---|---|---|---|---|---|---|---|---|---|
| 1001 | | glass | 1.6 | mm | 1.6 | mm | 1.6 | mm | 1.6 | mm | 1.6 | mm |
| 1003 | | PVB | 0.76 | mm | 0.76 | mm | 0.76 | mm | 0.76 | mm | 0.76 | mm |
| 1004 | 2003 | SiN | 3 | | | | | | | | | |
| | | SnZnO | | | | | | | | | | |
| | | SiZrN | 16 | | 21 | | 11 | | | | 32 | |
| | | CWO | | | 21 | | 20 | | | | | |
| | | TiOx | | | | | | | | | | |
| | | ZnO | 5 | | 5 | | 5 | | | | 5 | |
| | | NiCr | 1 | | 1 | | 1 | | | | 1 | |
| | 2002 | Ag | 13.4 | | 13.6 | | 13.7 | | | | 14.0 | |
| | 2001 | ZnO | 5 | | 5 | | 5 | | | | 5 | |
| | | SiZrN | 34 | | 22 | | 43 | | | | 32 | |
| | | CWO | 8 | | | | 30 | | | | | |
| | | ITO | | | | | 91 | | | | 66 | |
| 1002 | | glass | 2.1 | mm | 2.1 | mm | 2.1 | mm | 2.1 | mm | 2.1 | mm |

In example E1, the tungsten oxide layer is in the first module 2001, starting from the glass sheet 1002. In example E2, the tungsten oxide layer is in the second module 2003, starting from the glass sheet 1002. Example E3 differs from examples E1 and E2 in that it comprises a layer of doped tungsten oxide, CWO, in each of the two dielectric modules 2002, 2003 and a layer of indium tin oxide (ITO) in the first dielectric module 2001 starting from the glass sheet 1002.

An example E4 according to the invention, similar to example E3, is shown in Table 2.

TABLE 1

| | | | E4 | |
|---|---|---|---|---|
| 1001 | | glass | 1.6 | mm |
| 1003 | | PVB | 0.76 | mm |
| 1004 | 2003 | SiN | 11 | |
| | | WOₓ | 40 | |
| | | SiZrN | 3 | |
| | | ZnO | 5 | |
| | | NiCr | 1 | |
| | 2002 | Ag | 11.9 | |
| | 2001 | ZnO | 5 | |
| | | WOₓ | 17 | |
| | | SiN | 5 | |
| 1002 | | glass | 2.1 | mm |

Example E4 differs from example E3 in that it comprises a layer of pure sub-stoichiometric tungsten oxide, WOₓ, in each of the two dielectric modules 2002, 2003, and a layer of silicon nitride (SiN) in the first dielectric module 2001, starting from the glass sheet 1002.

Counterexample CE1 corresponds to examples E1 and E2. It differs in that it has no tungsten oxide layer. Counter-example CE2 corresponds to examples E3 and E4. It differs in that it has no tungsten oxide layer.

The thin layers of the functional coatings 1004 of examples E1 to E4 and of counterexamples CE1 to CE2 were deposited by magnetic-field-assisted cathode sputtering (magnetron method) whose characteristics are widely documented in the literature, for example in patent applications WO2012/093238 and WO2017/00602.

The nature of the targets used and the deposition conditions of examples E1 to E4 and counterexamples CE1 and CE2 are described in table 3.

Functional coatings are deposited directly on the glass sheet 1002. This glass sheet 1002 is a 2.1 mm-thick sheet of soda-lime-silica mineral glass. Just after deposition, the functional coatings were subjected to a heat treatment at 650° C. for 10 min.

TABLE 3

| | | Pressure | Ar | O2 | N2 | Power |
|---|---|---|---|---|---|---|
| | Target | (μbar) | (sccm) | (sccm) | (sccm) | (W) |
| TiOx | TiOx | 2 | 10 | 2 | 0 | 2000 |
| SnZnO | Sn60Zn40 | 2 | 7 | 44 | 0 | 1000 |
| SiN | Si:Al at 92:8% by | 5 | 7 | 0 | 14 | 2000 |
| | weight | | | | | |
| SiZrN | Si:Zr 27% by weight | 2 | 15 | 0 | 15 | 1000 |
| NiCr | NiCr 80:20 at. % | 2 | 20 | 0 | 0 | 70 |
| Ag | Ag | 8 | 40 | 0 | 0 | 210 |
| ZnO | ZnO:Al at 2% by | 2 | 40 | 2 | 0 | 1300 |
| | weight | | | | | |
| CWO | CWO:Cs/W 0.3-0.4 | 4-10 | 30-40 | 2-10 | 0 | 1300 |
| WOₓ | W pure | 12 | 40 | 60 | 0 | 1300 |

at. = atomic

The WOₓ layer was deposited on a tungsten metal target in an atmosphere containing 60% dioxygen at a pressure of 12 mTorr. The WOₓ layer is thus a layer of pure sub-stoichiometric tungsten oxide, WOₓ, with an x of approx. 2.9. It has a refractive index of around 2.2 at 550 nm.

Once deposition and heat treatment have been completed, each of the glass sheets 1002 with a functional coating 1004 is laminated with a lamination interlayer 1003 of 0.76 mm thick PVB and a second glass sheet 1001 of 1.6 mm thick soda-lime-silica mineral glass to form a laminated glazing as shown in FIG. 1.

The light transmission, TL, the “direct solar transmittance,” TE, and the “solar factor,” TTS (or T_{TS}) were measured and/or calculated according to ISO standard 13837:2021 Convention A for each example and counterexample.

The “selectivity”, s, defined as the ratio, TL/TTS, of the light transmission, LT, to the solar factor TTS, and the “solar selectivity”, SE, defined as the ratio, TL/TE, of the light transmission TL to the direct solar transmittance, TE, were calculated for each example and counterexample from the parameters measured and/or calculated previously.

For each example and counterexample, the colorimetric parameters a* and b* were measured and/or calculated in transmission (a*T, b*T) and in reflection relative to the first glass sheet 1001 (a*R1_65, b*R1_65) and relative to the second glass sheet 1001 (a*R2_65, b*R2_65) in the L*a*b* CIE 1976 chromatic space according to standard ISO 11664-4:2019 with a D65 illuminant and a visual field of 2° or 10° for the reference observer.

In the chromatic space, the characteristic a* is the chromatic position on a green-red axis (between −500 and 500), and b* is the chromatic position on a blue-yellow axis (between −200 and 200).

For each example and counterexample, the colorimetric parameters a* and b* were measured and/or calculated in transmission in reflection relative to the second glass sheet 1001 (a*R2_65p, b*R2_65_p) in the L*a*b* CIE 1976 chromatic space according to standard ISO 11664-4:2019 with a D65 illuminant under p-type polarized light and a visual field of 2° or 10° for the reference observer.

The chroma index, denoted Chroma_R2_p, was calculated from the colorimetric parameters a*R2_65_p, b*R2_65_p obtained in reflection relative to the second glass sheet 1002. This index expresses the degree of color purity, an important parameter for head-up windshield applications.

The electrical resistance, noted R2, of the surface was evaluated according to the 4-point measurement method as described in the article Measurement of Sheet Resistivities with the Four-Point Probe, F. M. Smits, Bell Syst. Tech. J., 711 (1958) or in the standard ASTM F390-11. Measurements were taken using an RT70V 4-point ohmmeter from Napson.

All the measurement and/or calculation results are grouped in Table 4.

TABLE 4

| | CE1 | CE2 | E1 | E2 | E3 | E4 |
|---|---|---|---|---|---|---|
| TST | 57.1 | 52.1 | 53.4 | 54.4 | 52.3 | 52.7 |
| TE | 51.9 | 46.3 | 47.7 | 47.9 | 45.5 | 47.4 |
| TL | 72.5 | 72.5 | 72.5 | 72.5 | 72.5 | 72.5 |
| s | 1.27 | 1.39 | 1.36 | 1.33 | 1.39 | 1.38 |
| a*T | −2.8 | −3.0 | −4.6 | −2.5 | −4.5 | −2.5 |
| b*T | 4.0 | 3.9 | 2.7 | 3.8 | 4.0 | 4.1 |
| R1_65 | 29.8 | 29.0 | 29.9 | 28.5 | 27.6 | 29.1 |
| a*R1_65 | 0.1 | 0.8 | 1.1 | −0.5 | 1.0 | −0.3 |
| b*R1_65 | 0.7 | 2.5 | 1.4 | −1.8 | 0.7 | −0.3 |
| R2 | 22.4 | 18.6 | 17.5 | 21.3 | 18.3 | 22.7 |
| R2_p | 18.7 | 17.1 | 15.8 | 18.9 | 16.9 | 17.1 |
| a*R2_p | 2.3 | 2.4 | 2.4 | 2.4 | 0.8 | 2.5 |
| b*R2_65_p | 1.0 | −0.5 | −0.5 | −0.7 | 2.1 | 0.2 |
| Chroma_R2_p | 2.5 | 2.5 | 2.5 | 2.5 | 2.2 | 2.5 |
| R2_65 | 31.3 | 28.2 | 27.6 | 30.9 | 28.3 | 31.0 |
| a*R2_65 | −0.1 | 0.7 | −0.3 | −0.2 | −0.7 | −1.0 |
| b*R2_65 | 1.7 | −0.9 | −1.0 | −0.2 | 1.2 | 1.3 |
| R² (Ω) | 2.56 | 2.35 | 2.50 | 2.45 | 2.44 | 2.95 |

For comparison purposes, Table 4 shows examples and counterexamples with the same light transmission value.

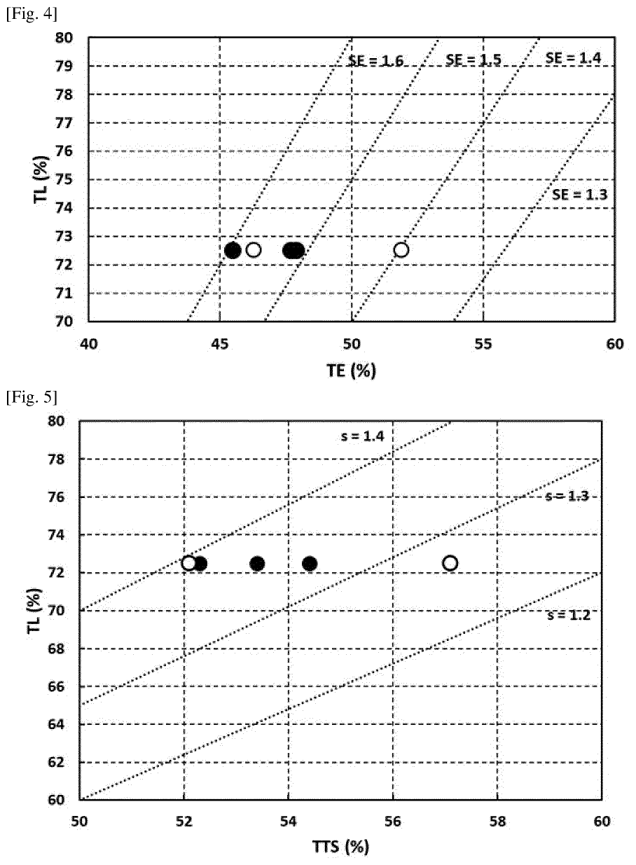

The values for light transmittance, TL, and direct solar transmittance, TE, for the examples (solid circles) and counterexamples (empty circles) are shown in FIG. 4. Also represented are the “solar selectivity” thresholds, SE, defined as the ratio, TL/TE, of the light transmission TL to the direct solar transmittance TE, as guides for the eyes.

Compared with counterexample CE1, examples E1 and E2 have a lower direct solar transmittance and therefore a higher solar selectivity value. Examples E3 and E4 both have a direct solar transmittance and solar selectivity value equivalent to counterexample CE2.

The values for light transmittance, TL, and total solar transmittance, TTS, for the examples (solid circles) and counterexamples (empty circles) are shown in FIG. 5. Also shown are “selectivity” thresholds, s, defined as the ratio, TL/TTS, of light transmission TL to total solar transmission, TTS, as guides for the eyes.

Compared with counterexample CE1, examples E1 and E2 have a total solar transmittance, TTS, that is around 3 to 5% lower and therefore a higher solar selectivity value. Examples E3 and E4 have a total solar transmittance and solar selectivity value equivalent to counterexample CE2.

All examples E1 to E4 have a reflection under p-type polarized light of over 15.5% and a neutral color with a chroma index of at most 2.5. These values are suitable for head-up display applications.

All examples E1 to E4 also have an electrical surface resistance of less than 2.5Ω, compatible with heating applications.

These examples clearly illustrate the advantages of laminated glazings, that is, they have higher selectivity and color compatibility for windshield head-up display and heating applications.

1. A laminated glazing comprising:
a first glass sheet;
a second glass sheet;
a lamination interlayer in adhesive contact with the first glass sheet and the second glass sheet;
a functional coating of thin layers arranged on the second glass sheet and comprising, starting from the second glass sheet, a first dielectric module, a metallic functional layer and a second dielectric module, said metallic functional layer being located between the first dielectric module and the second dielectric module;
wherein,
the first dielectric module and/or the second dielectric module comprise a tungsten oxide layer,
said tungsten oxide layer is made of pure sub-stoichiometric tungsten oxide, WOₓ, or
said tungsten oxide layer is doped tungsten oxide and comprises at least one doping element selected from the chemical elements of group 1 according to the IUPAC nomenclature.

2. The laminated glazing according to claim 1, wherein an optical refractive index of the tungsten oxide layer is decreasing monotonically with the wavelength from a maximum value greater than 2.4 at 350 nm up to a minimum value between 600 nm and 1400 nm so that a difference between the maximum value and the minimum value is greater than 0.8.

3. The laminated glazing according to claim 1, wherein an optical extinction coefficient of the tungsten oxide layer is less than 0.2 at 500 nm and less than 2.0 at 1200 nm.

4. The laminated glazing according to claim 1, wherein the tungsten oxide layer made of doped tungsten oxide comprises the doping element or several doping elements in proportions such that a molar ratio of said element to tungsten or a sum of the molar ratios of each element to tungsten is between 0.01 and 0.4.

5. The laminated glazing according to claim 1, wherein the tungsten oxide layer made of doped tungsten oxide comprises at least one doping element selected from hydrogen, lithium, sodium, potassium and cesium.

6. The laminated glazing according to claim 5, wherein the tungsten oxide layer made of doped tungsten oxide comprises cesium as a doping element, and a molar ratio of cesium to tungsten is between 0.01 and 0.4.

7. The laminated glazing according to claim 1, wherein a physical thickness of the tungsten oxide layer is between 2 nm and 50 nm.

8. The laminated glazing according to claim 1, wherein the first dielectric module and/or the second dielectric module comprise one or more layers of refractive index of less than 2.45 at 550 nm.

9. The laminated glazing according to claim 1, wherein the functional coating of thin layers further comprises a blocking metal overlayer located above and in contact with the metallic functional layer and/or a metallic blocking underlayer located below and in contact with the metallic functional layer.

10. The laminated glazing according to claim 1, wherein the first dielectric module and/or the second dielectric module comprise a layer based on indium tin mixed oxide, indium-zinc mixed oxide, fluorine-doped tin oxide, aluminum-doped zinc oxide, gallium-doped zinc oxide, antimony-doped tin oxide and/or niobium-doped titanium oxide.

11. The glazing according to claim 10, wherein a thickness of said layer is between 50 nm and 100 nm.

12. The laminated glazing according to claim 1, wherein the metallic functional layer is a silver-based layer.

13. A projection device for head-up display comprising:
a laminated glazing according to claim 1,
a head-up projector configured to emit electromagnetic radiation onto at least one zone of the laminated glazing, the electromagnetic radiation being at least partially polarized according to a p-polarization.

14. A method comprising providing a laminated glazing according to claim 1, for a head-up display in a land, sea or air vehicle.

15. A method for manufacturing a laminated glazing according to claim 1, wherein the tungsten oxide layer made of doped tungsten oxide is deposited by a magnetron sputtering method using a tungsten oxide target doped using a chemical element chosen from the chemical elements of group 1 according to the IUPAC nomenclature.

16. The laminated glazing according to claim 1, wherein x is between 2.55 and 2.98.

17. The laminated glazing according to claim 2, wherein the difference between the maximum value and the minimum value is greater than 1.0.

18. The laminated glazing according to claim 3, wherein the optical extinction coefficient of the tungsten oxide layer is less than 0.1 at 500 nm and less than 1.5 at 1200 nm.

19. The laminated glazing according to claim 4, wherein the sum of the molar ratios of each element to tungsten is between 0.01 and 0.2.

20. The laminated glazing according to claim 6, wherein the molar ratio of cesium to tungsten is between 0.01 and 0.2.
